(19) United States
(12) Patent Application Publication
(10) Pub. No.: US 2006/0145621 A1
(43) Pub. Date: Jul. 6, 2006

(54) Miniature bulb

(76) Inventor: Wun-Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/025,955

(22) Filed: Jan. 3, 2005

(51) Int. Cl. H01J 17/18

(52) U.S. Cl. 313/623

(57) ABSTRACT

The invention relates to a miniature bulb of a miniature bulb assembly, which can provide more effective lighting and has double secure shunt circuits for maintaining the electrical connection when the tungsten wire is burn out. The bulb includes two conductive wire having different lengths for connecting their top ends with the inclined tungsten wire. The bulb also has its top end becoming a convex lens with inner flat and outer convex to gather and increase lighting effect.

### FIELD OF THE INVENTION

The present invention relates to an improvement of a bulb, which is used on a miniature bulb assembly of a light string that provides better lighting effect being better than any prior ones.

### BACKGROUND OF THE INVENTION

A conventional miniature bulb, as shown in FIG. 1 and 2, includes a transparent glass shell (1) connecting with two conductive wires (11) passing through one end to extend outside. A tungsten wire (12) is connected between top ends of the conductive wires (11) and is perpendicular to the conductive wires (11). A secure wire (13) is provided between the two conductive wires (11) at middle portion for becoming a shunt circuit as the tungsten wire (12) is burn out.

### SUMMARY OF THE INVENTION

The present invention is to provide an improved miniature bulb, which can provide better lighting effect by use of the improvement including a convex lens on top of the shell and an inclined connecting tungsten wire between the conductive wires. Now, accompanying with the following drawings, the character of the present invention will be described here and after.

### BRIEF DESCRIPTION OF THE DRAWINGS

FIG. 1 is a perspective view showing a conventional miniature bulb.

FIG. 2 is a cross-sectional plan view of FIG. 1.

FIG. 3 is a perspective view showing a miniature bulb according to the present invention.

FIG. 4 is a cross-sectional plan view of FIG. 3.

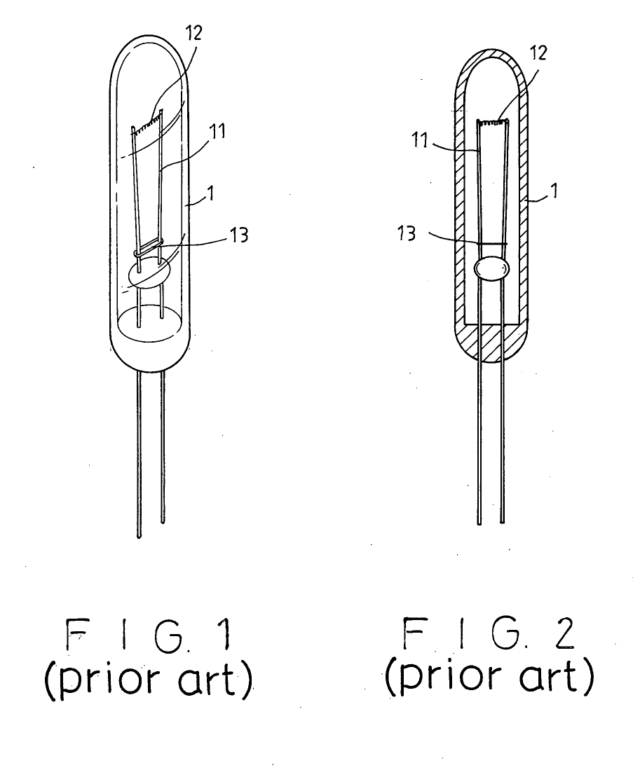

### DETAILED DESCRIPTION OF THE PREFERRED EMBODIMENT

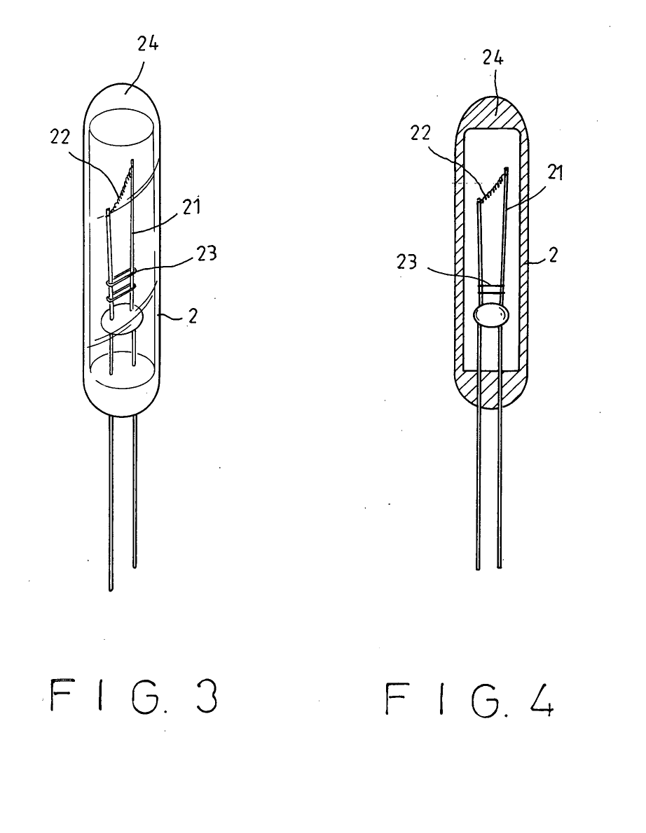

Please refer to FIG. 3 and 4, the present invention includes a glass shell (2) having two conductive wires (21) for connecting their top end with a tungsten wire (22). The improvement of the present invention is in that the lengths of the two conductive wires (21) are different. The tungsten wire (22) is inclined to be connected between the two conductive wires (22) and has thus a longer length. Further, two secure wires (23) are provided between the two conductive wires (21). The glass shell (2) has its top end to become a convex lens (24) having inner flat and outer convex.

Under such design of the present invention, the inclined tungsten wire (22) has a longer length that can produce more lighting as being electrical connection. And the convex lens (24) on the shell (2) can concentrate the light from the tungsten wire (22) to increase the shining effect of the miniature bulb that will be better than any conventional ones. Moreover, the bulb of the present invention is provided with two secure wires (24) for becoming a shunt circuit when the tungsten wire or one secure wire (24) is broken that provides double protecting purposes.

I claim:

1. A miniature bulb of a miniature bulb assembly including a glass shell having two conductive wires for connecting their top ends with a tungsten wire; the improvement is in that the lengths of the two conductive wires being different, the tungsten wire being inclined to be connected between the two conductive wires and having a longer length, two secure wires being provided between the two conductive wires, and the glass shell having its top end to become a convex lens having inner flat and outer convex.
